(19) United States
(12) Patent Application Publication
(10) Pub. No.: US 2007/0136159 A1
(43) Pub. Date: Jun. 14, 2007

(54) Accurate tax calculation and modeling

(76) Inventors: Rory Rawlings, Bainbridge Island, WA (US); Brian Hilst, Bainbridge Island, WA (US); Robert Heffron, Bainbridge Island, WA (US); Mark Withers, Bainbridge Island, WA (US)

Correspondence Address: PERKINS COIE LLP;PATENT-SEA, P.O. BOX 1247, SEATTLE, WA, 98111-1247, US

(21) Appl. No.: 11/542,630

(22) Filed: Oct. 2, 2006

Related U.S. Application Data
(63) Continuation of application No. 11/336,414, filed on Jan. 20, 2006.
(60) Provisional application No. 60/749,529, filed on Dec. 12, 2005.

(51) Int. Cl. G07F 19/00

(52) U.S. Cl. 705/31

(57) ABSTRACT

A facility for accurately computing taxes is described. In various embodiments, the facility requests transaction information from a universal connector, requests a tax service provider to calculate taxes based on the transaction information, and reports the calculated taxes. In various embodiments, the facility additionally receives business practice change information and requests the tax service provider to calculate taxes based on the business practice change information.

### CROSS-REFERENCE TO RELATED APPLICATION(S)

This application claims the benefit of U.S. Provisional Patent Application No. 60/749,529, filed on Dec. 12, 2005, entitled, “ACCURATE TAX CALCULATION,” which is incorporated herein by reference in its entirety.

### BACKGROUND

When a business purchases, sells, or uses goods or services, it may owe taxes to various tax collection agencies. Goods or services may be subject to various excise taxes, such as sales taxes, use taxes, value-added taxes, and so forth (collectively, “taxes”). Moreover, the taxes may vary across jurisdictional lines. As an example, goods or services may be subject to sales taxes in one jurisdiction, use taxes in another jurisdiction, and no taxes in a third jurisdiction. In some situations, taxes may be calculated based on the origin or destination of the goods depending on the jurisdiction of the manufacturer, distributor, or acquirer. Businesses generally report the amount of taxes they owe and pay corresponding amounts to various tax collection agencies. When businesses fail to accurately report and pay taxes they owe, they may be subject to audits and fines.

Businesses generally collect information relating to their operations, such as by using enterprise resource planning (“ERP”) applications and accounting applications. ERP applications manage information relating to a business's activities, such as sales, resource management, production, inventory management, delivery, billing, and so forth. Accounting applications manage a business's accounting information, such as purchase orders, sales invoices, payroll, accounts payable, accounts receivable, and so forth.

ERP applications, accounting applications, and other conventionally used applications generally cannot provide accurate tax information, such as when transactions are complex or span geographical boundaries. As an example, these applications may over- or under-estimate tax owed to governments, e.g., because they fail to consider municipal taxes. Moreover, these applications generally do not provide an ability for businesses to model the impact various changes may have on the business's “bottom line.” As an example, these applications cannot model the impact on taxes of transferring production of goods from one geographical area (e.g., tax jurisdiction) to another. It would thus be highly desirable to provide a facility that accurately calculates taxes and enables the business to determine how a change in its business practices (e.g., a reorganization) could impact taxes.

### BRIEF DESCRIPTION OF THE DRAWINGS

FIG. 1 is a block diagram of a basic and suitable computer that may employ aspects of the invention.

FIG. 2 is a block diagram illustrating an environment in which the facility operates in some embodiments.

FIG. 3 is a table diagram illustrating database tables associated with the facility in various embodiments.

FIG. 4 is a flow diagram illustrating a calculate_taxes routine invoked by the facility in some embodiments.

FIG. 5 is a flow diagram illustrating a model_changes routine invoked by the facility in some embodiments.

FIG. 6 is a block diagram illustrating an environment in which a tax service appliance may operate.

FIG. 7 is a block diagram illustrating a tax service appliance of FIG. 6 in further detail.

FIG. 8 is a flow diagram illustrating a computer_taxes routine.

### DETAILED DESCRIPTION

A software facility (“facility”) and a tax service appliance are described.

### Tax Facility

The facility enables a business to accurately calculate taxes and further enables the business to determine how a change in its business practices could impact taxes. In various embodiments, the facility employs a universal connector to retrieve relevant information from ERP and accounting applications, calculates tax information based on the retrieved information using a tax service provider, and prepares reports containing the calculated tax information.

The universal connector can connect with multiple ERP, accounting, and other applications, such as from different vendors, to provide a consistent interface to information that is contained in databases associated with these various ERP and accounting applications. As an example, the universal connector may provide an application program interface (API) to retrieve information from the various databases in a common and known structure even though the various databases may store the information in dissimilar structures. Various universal connectors are commercially available, such as from TIBCO Software, BEA Systems, and SAP Software.

In some embodiments, the facility employs the universal connector in a batch processing mode. Database queries and calculations are grouped and processed together in this batch processing mode. The facility may employ the universal connector in the batch processing mode so that it can generate reports based on a collection of appropriate information. In some embodiments, the facility employs the universal connector for “real-time” access to data.

The facility requests the universal connector via the universal connector's API to retrieve information that the facility can use to calculate tax information. As an example, to calculate tax information corresponding to purchased goods or services, the facility requests the universal connector to retrieve a list of vendor identifiers (“vendor IDs”) and associated transactions and accounts payable information for each identified vendor.

The facility employs a tax service provider to calculate tax information based on the information the universal connector retrieved from the various databases. The tax service provider may provide services via software or hardware. As an example, the tax service provider may provide a web service that receives transaction information and provides tax information. As another example, the tax service provider may employ a tax service appliance, such as the tax service appliance that is described in further detail below.

The facility can provide reports that summarize the collected information, such as in reports relating to transactions, accounts payable, and taxes.

In some embodiments, the facility receives configuration information that it employs or provides to the tax service provider to accurately calculate taxes. As an example, the facility receives information relating to the purpose for which a particular item is sold or used. As another example, the facility receives information relating to general ledger account numbers, such as how goods or services corresponding to these general ledger account numbers are to be taxed. In some embodiments, the facility provides an indication of an exposure to a tax audit. As an example, when the facility detects that a calculated tax exceeds taxes actually paid, the facility may indicate that an audit is likely.

In some embodiments, the facility enables a business to determine how a change in its business practices could impact taxes. To make this determination, the business can identify different purposes for various general ledger accounts, indicate a different jurisdiction where items are purchased from or assembled, and so forth. As an example, the business can consider outsourcing manufacture of an item it previously manufactured itself. As another example, the business can consider moving an existing manufacturing unit from one jurisdiction to another. Upon modeling these changes, the facility reports recalculated values. In this way, the facility is able to recalculate taxes that may be owed based on these business practice changes. Upon performing these calculations, the facility may be able to provide an indication of a likelihood of an audit. As an example, when the facility detects that taxes owed as a result of changes in business practices would be substantially lower than in a prior year, the facility may indicate that an audit is likely. The facility may also use other heuristics to determine whether an audit is likely.

In some embodiments, the facility provides an API that another application can use to retrieve information. As an example, the other application can employ the facility's API to retrieve accounts payable information, calculate taxes, generate reports, and so forth.

In some embodiments, the facility provides a user interface (UI), such as a graphical user interface (GUI). A user can use the UI to interact with the facility, such as to generate a report or to model changes in business practices.

### Tax Service Appliance

In various embodiments, the tax service appliance acts as a proxy for a tax service data center that provides tax services electronically. As an example, the tax service data center may host a web service that receives transaction information and provides tax information corresponding to the transaction.

In various embodiments, a tax service appliance can be located in a tax service data center, customers' premises, or both. A tax service appliance that is located in the tax service data center can respond to requests for tax information, such as from a device located in a customer's premises. A tax service appliance that is located on customers' premises can act as a proxy for the tax service data center in the customer's local area network.

The tax service appliance is a computing device. In various embodiments, the tax service appliance includes standard computing device components (e.g., processor, storage, input/output interfaces, and so forth) and a database. The database may store information that enables the tax service appliance to act as a proxy for the tax service data center. As an example, the tax service appliance may store tax data, rules, laws, and other information that may be needed to calculate taxes for a transaction. The tax service appliance may also store transaction information for forwarding to the tax service data center.

In various embodiments, the tax service appliance receives transaction information from accounting and ERP applications and provides tax information relating to the transaction. As an example, the tax service appliance receives transaction information, determines taxes to apply to the transaction, stores the transaction and determined tax information, and provides the determined tax information, such as to an accounting or ERP application. In some embodiments, the tax determination occurs when a transaction occurs, e.g., at a point of sale (POS) terminal. In some embodiments, the determination occurs in a batch mode, such as prior to submitting taxes to a tax collection agency or when modeling a change in business practices.

The tax service appliance determines taxes according to various tax data, rules, laws, holidays, and so forth. In various embodiments, this information is stored either in the tax service appliance, at the tax service data center, or both. The tax service appliance may synchronize data with the tax service data center from time to time. As an example, a tax service appliance located on a customer's premises may periodically download a subset of data available at the tax service data center that particularly pertains to the customer's operations (e.g., the jurisdictions in which the customer operates). The tax service appliance may also upload transaction details to the tax service data center, such as for tax collection or reporting purposes. In some embodiments, the tax service appliance determines taxes according to information it stores and transaction information it receives. In some embodiments, the tax service data can forward transaction information to a tax service data center and receives calculated taxes from the tax service data center. In various embodiments, the tax service appliance may send requests to the tax service data center and receive responses to the requests. As examples, the tax service appliance can request updates to information it stores, tax-related information pertaining to a jurisdiction in which the customer has begun operating, tax-related information for new SKUs, etc.

In some embodiments, the tax service appliance works autonomously from the tax service data center. When the tax service appliance has tax-related information, such as after downloading this information from the tax service data center, the tax service appliance can calculate taxes and record transaction information even when its network connection to the tax service data center is temporarily unavailable. Thus, the tax service appliance can act as a proxy for the tax service data center.

In some embodiments, identical (or substantially similar) tax service appliances can be employed at both tax service data centers and at customers' premises. In some embodiments, tax service appliances can connect directly or indirectly with various POS terminals that are commercially available.

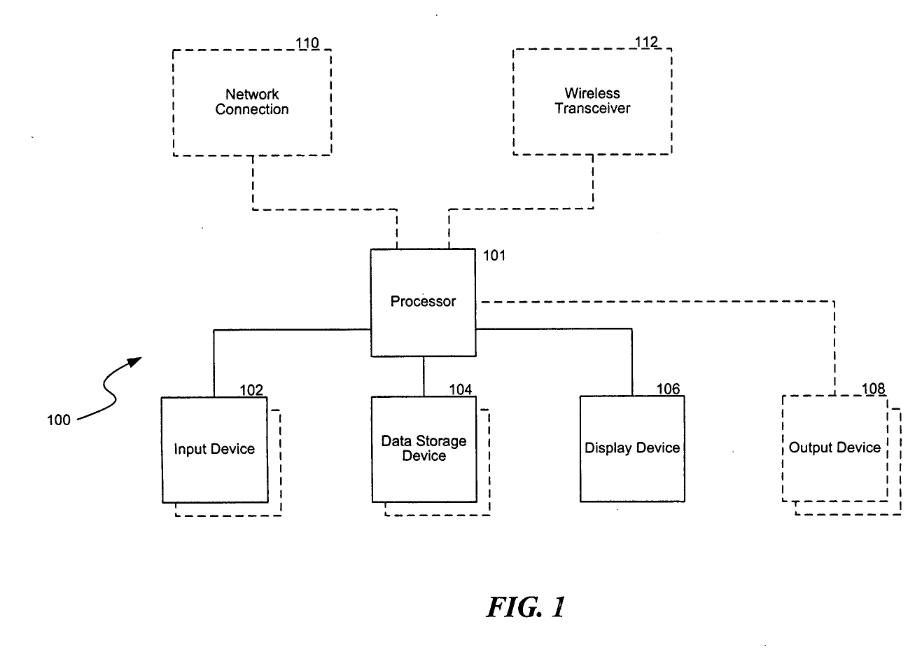

Turning now to the figures, FIG. 1 and the following discussion provide a brief, general description of a suitable computing environment in which aspects of the invention can be implemented. Although not required, aspects and embodiments of the invention will be described in the general context of computer-executable instructions, such as routines executed by a general-purpose computer, e.g., a server or personal computer. Those skilled in the relevant art will appreciate that other computer system configurations can be employed, including Internet appliances, hand-held devices, wearable computers, cellular or mobile phones, multi-processor systems, microprocessor-based or programmable consumer electronics, set-top boxes, network PCs, mini-computers, mainframe computers and the like. A special-purpose computer or data processor that is specifically programmed, configured or constructed to perform one or more of the computer-executable methods explained in detail below can be employed. Indeed, the term “computer”, as used generally herein, refers to any of the above devices.

Distributed computing environments can be employed, wherein tasks or modules are performed by remote processing devices that are linked through a communications network, such as a Local Area Network (“LAN”), Wide Area Network (“WAN”) or the Internet. In a distributed computing environment, program modules or subroutines may be located in both local and remote memory storage devices. Aspects of the invention described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer.

Referring to FIG. 1, various embodiments employ a computer 100, such as a personal computer or workstation, having one or more processors 101 coupled to one or more user input devices 102 and data storage devices 104. The computer may also be coupled to an output device, such as a display device 106, and one or more optional additional output devices 108 (e.g., printer, plotter, speakers, tactile output devices, etc.). The computer may be coupled to external computers, such as via an optional network connection 110, a wireless transceiver 112, or both.

The input devices 102 may include a keyboard and/or a pointing device such as a mouse. Other input devices are possible, such as a microphone, joystick, pen, game pad, scanner, digital camera, video camera, radio frequency identification (RFID) transceivers or receivers, and so forth. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet (not illustrated in FIG. 1).

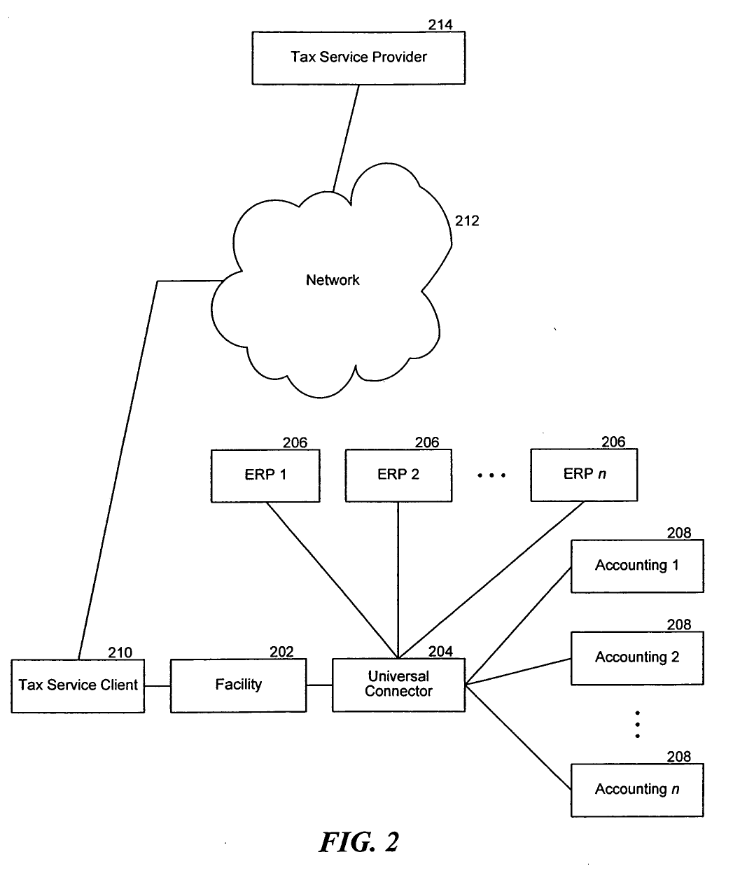

FIG. 2 is a block diagram illustrating an environment in which the facility operates in some embodiments. The environment includes the facility 202, and a universal connector 204. The facility requests the universal connector to retrieve information from various applications and databases, such as databases associated with one or more ERP applications 206 and accounting applications 208. The universal connector, upon receiving a request from the facility, requests one or more of these applications to retrieve and provide the information. In some embodiments, the universal connector accesses the databases associated with these applications directly. In various embodiments, these applications may provide or store information in different formats. As an example, these applications may each have a different schema corresponding to associated databases. The universal connector transforms information it receives from each of these applications into a format that is known by the facility. As a result, the facility does not need to be configured to operate with the various formats of the applications.

In some embodiments, the facility may employ a tax service client 210 to calculate taxes based on information the facility retrieved using the universal connector. In some embodiments, a tax service is a software component that employs a web service, such as the tax service provider 214. In these embodiments, the tax service may communicate with the tax service provider via a network 212, such as the Internet. In some embodiments, the tax service client 210 is a tax service appliance. The tax service appliance may communicate with a tax service provider, such as through a network 212. In some embodiments, the tax service additionally caches information that either the facility or the tax service provider may require.

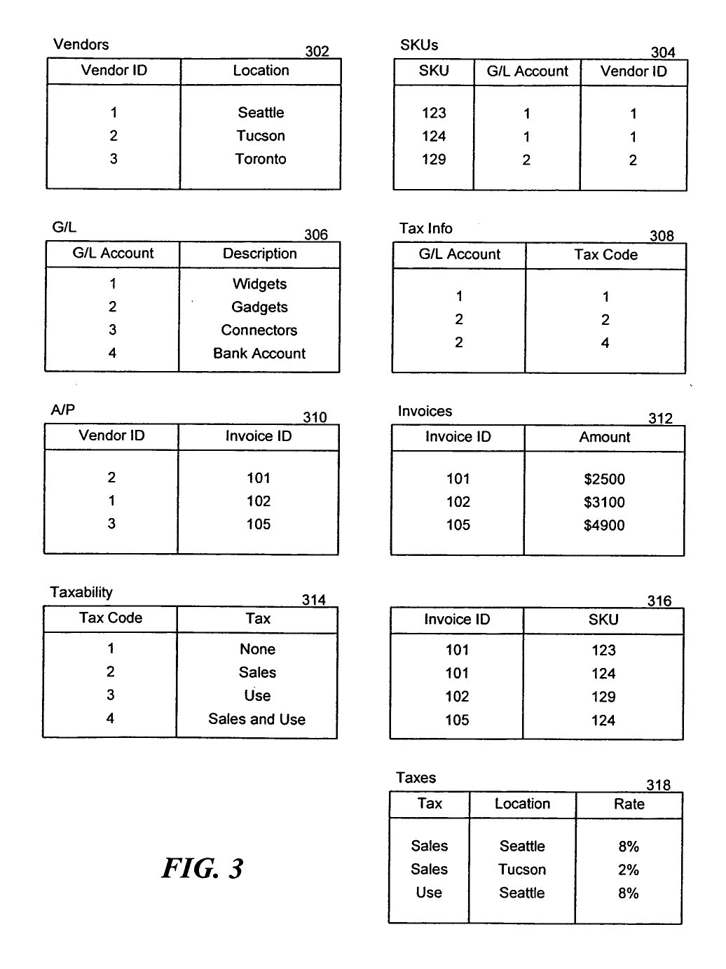

FIG. 3 is a table diagram illustrating database tables associated with the facility in various embodiments. A vendors table 302 stores a list of vendors from which the business using the facility may have acquired products or services. A stock keeping unit (SKU) table contains a list of SKUs associated with items the business acquires. Each SKU is associated with a general ledger (G/L) account and vendor. The SKUs table is related to the vendors' table via the Vendor ID column. The SKUs table is also related to the G/L table 306. Thus, for a given item, the facility can easily determine which G/L account the SKU belongs to and which vendor supplies the items corresponding to the SKU.

Table 306 contains a list of general ledger accounts. Table 308 contains a list of correspondences between general ledger accounts and taxability information. Each general ledger account has a corresponding tax code. This tax code relates the tax information table with the taxability information table 314. Thus, for example, by performing a query on a particular SKU, it is possible to determine the taxability of the SKU. This query may require a join operation between the SKUs table, tax information table, and taxability information table.

In various embodiments, the facility also employs an accounts payable (A/P) table 310 and invoices table 312. The A/P table contains a list of correspondences between vendors and invoices. Based on this correspondence, the facility is able to calculate taxes that a business using the facility owes. As an example, based on a location of a particular vendor, the facility is able to determine how much tax is owed on each invoice. Each invoice additionally comprises one or more SKUs, as indicated in table 316.

Table 318 contains a list of tax rates for each type of tax and jurisdiction. The facility can employ this table to determine the tax rate, such as by joining this table with the taxability table and other tables.

While FIG. 3 and its discussion shows tables whose contents and organization are designed to make them more comprehensible by a human reader, those skilled in the art will appreciate that actual data structures used by the facility to store this information may differ from the table shown, in that they, for example, may be organized in a different manner, may contain more or less information than shown, may be compressed and/or encrypted, etc. As an example, some of the tables may be associated with the facility while other tables may be associated with the tax service provider.

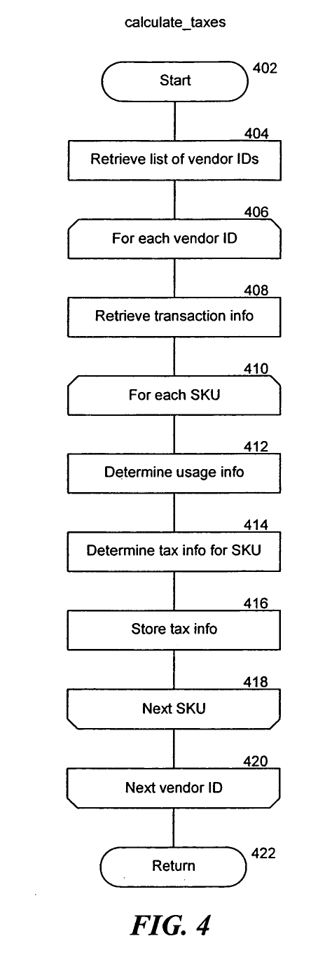

FIG. 4 is a flow diagram illustrating a calculate_taxes routine invoked by the facility in some embodiments. The routine begins at block 402. At block 404, the routine retrieves a list of vendor IDs, such as from a vendor ID table. The facility may request this information and other information acquired by the routine by using a universal connector component. Between the loop of blocks 406 to 420, the routine determines tax information corresponding to each vendor in the retrieved list of vendors. At block 406, the routine selects a vendor ID.

At block 408, the routine retrieves transaction information associated with the vendor. As an example, the routine may retrieve SKUs acquired from the vendor and the G/L accounts to which the SKUs correspond.

Between the loops of block 410 and 418, the routine processes each SKU to determine taxability information. At block 410, the routine selects a SKU from the list of SKUs.

At block 412, the routine determines usage information relating to the SKU. As an example, the routine determines from the general ledger and other associated tables how to treat the selected SKU for taxation purposes. As an example, the facility can join the SKUs, G/L, tax info, and taxability tables to determine that a particular SKU should not be taxed or the type and rate of tax to apply. At block 414, the routine employs the taxes table 318 to determine the weight of tax reply.

At block 416, the routine stores the calculated tax, such as in a table corresponding to tax information that will be transmitted to a tax collection agency or employed for creating a report.

At block 418, the routine selects another SKU. When all SKUs have been processed, the routine continues at block 420. Otherwise, the routine continues at block 412.

At block 420, the routine selects another vendor ID. When all vendor IDs have been processed, the routine continues at block 422, where it returns. Otherwise, the routine continues at block 408.

In various embodiments, the logic of blocks 412 and 414 are performed by a tax service provider, such as the tax service appliance.

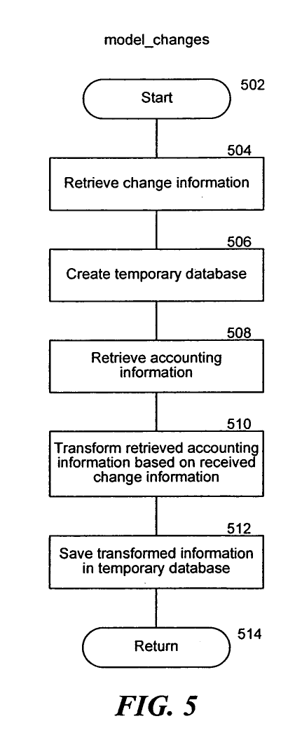

FIG. 5 is a flow diagram illustrating a model_changes routine invoked by the facility in some embodiments. The facility invokes this routine to determine changes in accounting or taxability information that would result from changes in business practices. The routine begins at block 502.

At block 504, the routine retrieves business practice change information, such as from a table indicating how various general ledger accounts are to be treated. As an example, the business practice change information may indicate that a particular SKU is to be acquired from a different vendor that is located in a jurisdiction other than the jurisdiction from which the SKU is presently being acquired. As another example, the business practice change information may indicate that items that were previously being manufactured are to be acquired from a vendor.

At block 506, the routine creates a temporary database in which to store accounting or tax information. As an example, the routine may create a temporary accounting database.

At block 508, the routine retrieves accounting information. As an example, the routine may employ the universal connector component to acquire the accounting information from an accounting system or an ERP system.

At block 510, the routine transforms the retrieved accounting information based on the business practice change information received at block 504. As an example, the routine may determine that a particular item is to be taxed at a different rate because the vendor supplying the item is located in the different jurisdiction than the vendor from which the SKU is presently acquired. As another example, the routine may consolidate various general ledger accounts because an item is no longer being manufactured.

At block 512, the routine saves the transform information in the temporary database that was created at block 506.

The routine returns at block 514. Various reporting tools may be used to create reports from the temporary database. As an example, a user may use a report generation tool that retrieves information from the temporary database to produce a meaningful report.

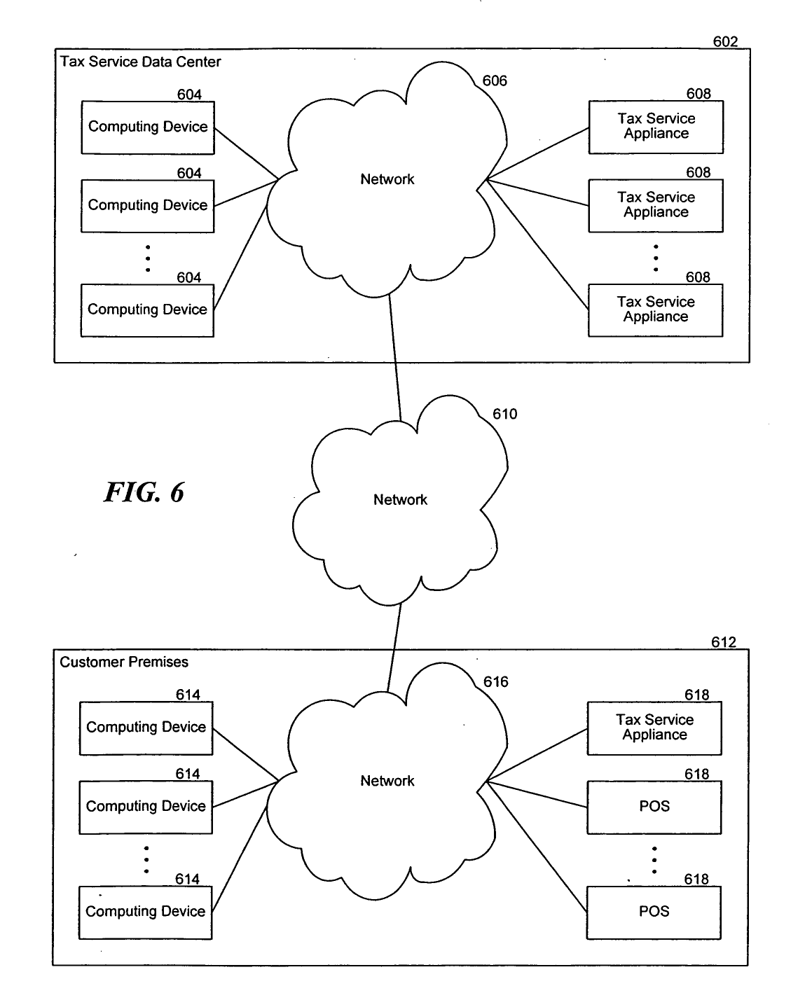

FIG. 6 is a block diagram illustrating an environment in which a tax service appliance may operate. A tax service data center 602 provides various tax-related services. The tax service data center contains multiple computing devices 604. These computing devices can be client or server computing devices and may have an architecture similar to the computers illustrated in FIG. 1 and described above. One or more of these computing devices may store various databases associated with the tax-related services provided by the tax service data center. One or more of these computing devices may also provide a web service, such as via a network 610, such as the Internet. In various embodiments, the web service provides various tax-related services, such as tax computation, tax information collection, and tax reporting.

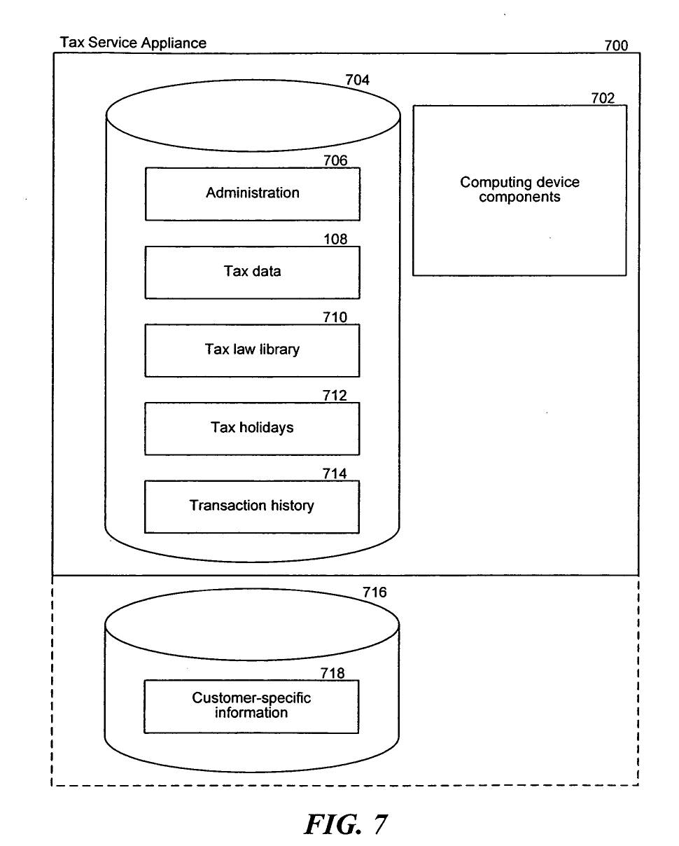

In various embodiments, the computing devices are connected via a network 606, such as an intranet, to one or more tax service appliances 608. Tax service appliances are described in further detail below in relation to FIG. 7. The tax service appliances in the tax service data center may employ data stored in, and services provided by, the computing devices 604.

Services provided by the tax service data center may be employed by a customer requiring tax-related services. In various embodiments, such customers employ devices associated with their customer premises 612. Such devices are commonly referred to as customer premises equipment. Customer premises equipment includes various computing devices 614. These computing devices can be client or server computing devices and may have an architecture similar to the computers illustrated in FIG. 1 and described above.

In various embodiments, the computing devices are connected via a network 616, such as an intranet, to one or more tax service appliances 618 (though only one is illustrated). Tax service appliances are described in further detail below in relation to FIG. 7. The tax service appliances in customer premises may employ data stored in, and services provided by, various computing devices 614. As examples, the tax service appliances may request or receive information from applications or databases associated with these computing devices.

In various embodiments, the customer premises include one or more POS terminals 620. A POS terminal is generally a device that connects to various computing devices, such as a business's inventory system or a credit card company's authorization system, to authorize, record, and forward information relating to sales. Information relating to each sale may be stored in an accounting or ERP application.

FIG. 7 is a block diagram illustrating a tax service appliance of FIG. 6 in further detail. A tax service appliance 700 is generally a computing device, and so contains many components 702 found in other computing devices, such as the computer illustrated in FIG. 1 and described above. However, unlike some computing devices, the tax service appliance may not have some components commonly associated with computing devices, such as a computer monitor, keyboard, and so forth. The tax service appliance may include an embedded operating system.

In some embodiments, a tax service appliance additionally contains storage 704 that stores components and information relating to administration, taxes, and transactions.

In various embodiments, the tax service appliance generally forwards requests it receives to a tax service data center except in various circumstances, such as when a network connection is unavailable between the tax service appliance and the tax service data center. When a network connection is unavailable, the tax service appliance may handle requests by employing services and information it stores. These services and information are provided by administration 706, tax data 708, tax law library 710, tax holidays 712, and transaction history 714 components. In various embodiments, these components comprise executable components, data stored in databases, or both.

The administration component stores information relating to users, “nexus” information relating to jurisdictions in which the customer employing the tax service appliance has a tax liability, and other information relating to the tax service appliance or the facility. In some embodiments, the administration component additionally stores information relating to exemption certificates. An exemption certificate enables a business to avoid paying taxes on goods or services to which the exemption certificate applies. The administration component generally stores information associated with a particular business. In some embodiments, the administrative component either does not exist or is inoperative when the tax service appliance is located in a tax service data center.

The tax data component stores tax-related information such as tax rates applied to various goods or services, jurisdictions (e.g., geographic boundaries) in which the tax rates apply, and so forth. This tax-related information generally applies to all businesses.

The tax law library component stores information relating to various tax rules, such as whether particular goods are subject to sales taxes, use taxes, or both; how taxes are to be calculated for these particular goods or services; and so forth. The tax law library component may evaluate information relating to an underlying transaction, such as where the goods or services originated, where they are destined, what value was added, and so forth.

The tax holidays component stores information relating to tax holidays. A tax holiday is a reduction or elimination of a tax, such as on a temporary basis. This information is employed when calculating taxes.

The transaction history component stores transactions, such as when indications of transactions are received from an accounting or ERP application or a POS terminal. This component can store information relating to taxes that are payable various tax collection agencies.

In some embodiments, the tax service appliance may additionally employ a customer-specific information component 718. This component may reside in the tax service appliance or may reside in another computing device. In some embodiments, the customer-specific information may reside in a separate database 716.

In some embodiments, a tax service appliance located on a customer's premises may store only a subset of tax-related information that is stored in a tax service appliance that is located in a tax service data center. As an example, when a business operating the tax service appliance only operates in some jurisdictions, information relating to other jurisdictions may be unnecessary for daily operations. In some embodiments, the tax service appliance may request some of this additional information that it does not store, such as when a transaction occurs with an entity that is located in another jurisdiction for which the tax service appliance does not store tax-related information.

In various embodiments, a tax service appliance located on a customer's premises may exchange information with a tax service appliance (or other computing device) that is located in a tax service data center. As an example, the tax service appliance located on the customer's premises may provide transaction information to the tax service appliance (or other computing device) that is located in the tax service data center, and may receive updated tax-related information from the tax service data center.

Thus, in various embodiments, the tax service appliance is a network edge appliance that enables a business to expand the capabilities of existing applications, such as accounting and ERP applications.

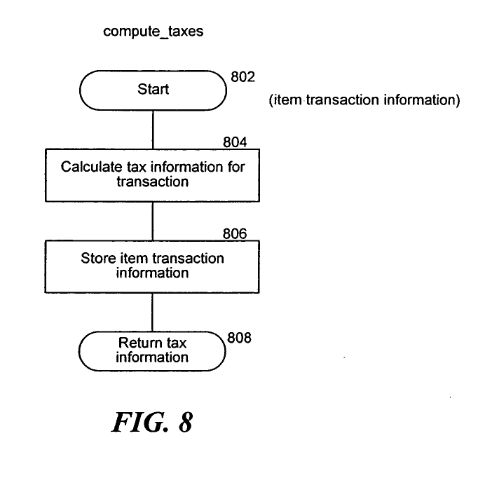

FIG. 8 is a flow diagram illustrating a compute_taxes routine. The routine is performed by a tax service appliance to calculate taxes relating to a transaction. The routine begins at block 802 where it receives indications of information about the transaction as parameters. As an example, the routine may receive information such as a SKU, customer's address, supplier's address, date of sale, and so forth.

At block 804, the routine calculates tax information for the transaction. As an example the routine may determine whether taxes are to be excised based on the SKU and date, which jurisdictions' taxes are to be applied based on addresses, and so forth.

At block 806, the routine stores the indicated item transaction information, such as in the transaction history.

At block 808, the routine returns the tax information it calculated at block 804.

Those skilled in the art will appreciate that the blocks shown in FIGS. 4-5, FIG. 8 and in their corresponding discussions may be altered in various ways. For example, the order of the blocks may be rearranged, substeps may be performed in parallel, shown blocks may be omitted, or other blocks may be included, etc.

While various embodiments are described in terms of the environment described above, those skilled in the art will appreciate that the facility may be implemented in various other environments including a single, monolithic computer system, as well as various other combinations of computer systems or similar devices connected in various ways.

It will be appreciated by those skilled in the art that the above-described facility may be straightforwardly adapted or extended in various ways. As an example, the tax service appliance located on a customer's premises may communicate with a web service in addition to, or instead of, a tax service appliance located in a tax service data center. While the foregoing description makes reference to particular embodiments, the scope of the invention is defined solely by the claims that follow and the elements recited therein.

I/We claim:

1. A computer-readable medium having computer-executable instructions for performing a method of accurately computing taxes, the method comprising:
receiving business practice change information, the business practice change information indicating at least a change in tax treatment for a general ledger account;
requesting transaction information from a universal connector that is capable of receiving transaction information from multiple applications in disparate forms and providing a common interface to the transaction information; and
requesting a tax service provider to calculate taxes based on the transaction information and the business practice change information; and
reporting the calculated taxes.

2. The method of claim 1 wherein the tax service provider is a web service.

3. The method of claim 1 wherein the tax service provider is a tax service appliance.

4. The method of claim 1 wherein the business practice change information further includes an indication to consolidate several general ledger accounts.

5. The method of claim 1 further comprising providing an indication that a tax audit is likely.

6. The method of claim 5 wherein the likelihood is based on the calculated taxes.

7. The method of claim 1 wherein the business practice change information further comprises an indication that items previously produced by a manufacturing unit are to be outsourced.

8. The method of claim 1 wherein the taxes are calculated in a batch processing mode.

9. A method performed by a computing system to accurately compute taxes, comprising:
requesting transaction information from a universal connector that is capable of receiving transaction information from multiple applications in disparate forms and providing a common interface to the transaction information;
requesting a tax service provider to calculate taxes based on the transaction information; and
reporting the calculated taxes.

10. The method of claim 9 wherein the tax service provider is a web service.

11. The method of claim 9 wherein the tax service provider is a tax service appliance.

12. The method of claim 9 further comprising receiving business practice change information.

13. The method of claim 12 wherein the tax calculation includes employing the received business practice change information to calculate the taxes.

14. The method of claim 12 wherein the received business practice change information includes indications of general ledger account numbers whose tax treatment changes.

15. The method of claim 9 wherein the universal connector operates with an accounting system.

16. The method of claim 9 wherein the universal connector operates with an enterprise resource planning system.

17. A system for accurately computing taxes, comprising:
a tax service provider;
a tax service client that communicates with the tax service provider to receive tax-related information;
a universal connector that provides information from an application; and
a software facility that receives information from the universal connector, provides the received information to a tax service client, and requests the tax service client to calculate taxes based on the received information.

18. The system of claim 17 wherein the received information relates to transactions.

19. The system of claim 17 wherein the tax service client is a tax service appliance.

20. The system of claim 17 wherein the tax service provider is a web service.
